(19) United States
(12) Patent Application Publication
(10) Pub. No.: US 2017/0130021 A1
(43) Pub. Date: May 11, 2017

(54) FORMAMIDE-FREE FOAM AND METHOD FOR PREPARING THE SAME

(71) Applicant: LIANG HAW TECHNOLOGY CO., LTD., TAIPEI CITY (TW)

(72) Inventors: FANG-JUEI CHOU, TAIPEI CITY (TW); LI-CHUN YU, TAIPEI CITY (TW); CHUN-YUNG YU, TAIPEI CITY (TW); HAN-HSING HSIUNG, TAIPEI CITY (TW)

(21) Appl. No.: 15/346,126

(22) Filed: Nov. 8, 2016

(30) Foreign Application Priority Data
Nov. 11, 2015 (TW) 104137154

(51) Int. Cl. C08J 9/00; C08J 9/08

(52) U.S. Cl. CPC C08J 9/0061; C08J 9/08; C08J 9/009; C08J 2203/02; C08J 2201/026; C08J 2323/06; C08J 2431/04

(57) ABSTRACT

A formamide-free foam prepared by using sodium bicarbonate as a foaming agent and electron-beam irradiation for crosslinking is revealed. After copolymer and sodium bicarbonate being mixed evenly, the mixture is heated and compounded to form an intermediate. Then the intermediate is pressed and injected to form a sheet. Next the intermediate is irradiated by an electron-beam to form crosslinks therein. At last the intermediate is heated and foamed to get a formamide-free foam. Compared with foam produced by using azodicarbonamide as the foaming agent available now, formamide-free foam not only causes no harm to human health but also gives no negative effect to the environment during recycling. Thus the formamide-free foam is really environmentally friendly.

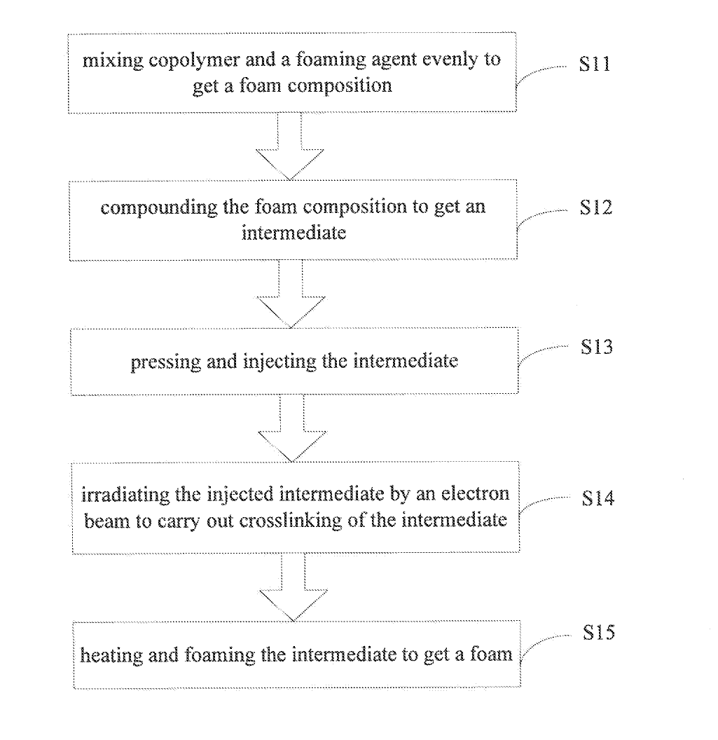

### BACKGROUND OF THE INVENTION

Field of the Invention

The present invention relates to a foam and a method for preparing the same, especially to a formamide-free foam and a method for preparing the same.

Descriptions of Related Art

Ethylene Vinyl Acetate (EVA) is the copolymer of ethylene and vinyl acetate. The EVA polymer offers good softness and elasticity by control of vinyl acetate content (VA content) thereof. The EVA polymer maintains good flexibility even at low temperature. The transparency, surface brightness, oxidation resistance and chemical stability of EVA are better than those properties of other polymers. The EVA can be applied to foam products owing to its good buffering effect, shock resistance, thermal insulation, moisture resistance and chemical corrosion resistance. The EVA foam is an ideal material for shoes, construction, pads or cushions.

The EVA can be divided into several types according to the VA content contained therein for being applied to industrial designs. For example, EVA emulsion with the VA content of 60%˜90% is used as an adhesive coating and a modifier. EVA elastomer with the VA content of 40%˜60% is applied as a toughener and vehicle accessories. The EVA resin with the VA content of 5%˜40% has the widest range of applications including film production, wires and cables, foam products, molded products, hot-melt adhesives, etc. Thus the EVA resin is a quite important material for plastic fiber manufacturers.

Besides being used independently as polymer, EVA can also be mixed with other polymer for modification of properties such as physical properties. For example, the polymer blends of EVA and polyethylene (PE) not only have high chemical stability, low temperature toughness, light weight and low cost like PE but also offer improved flexibility and resistance to environmental stress cracking. Thus the polymer blends have a wider range of applications and greater commercial value owing to better flexibility, processing stability, and air permeability thereof. EVA can also be mixed with PP for modification. The modified PP polymer has a better toughness, higher impact strength and ductility. Thus the modified PP is not only easy to be processed but also having a lower cost than other PP copolymers.

A foaming agent is required for formation of micropores in polymer while producing EVA polymer or EVA/PE, EVA/PP copolymer. The foaming agent mainly includes organic azo compounds and inorganic bicarbonates. Among azo compounds, azodicarbonamide (ADCA, AC blowing agent) is the most commonly used. Refer to Chinese Pat. Pub. No. CN102504398A, modified EVA foaming body and preparation method and application of the same are revealed. The foaming agent used in this prior art is ADCA. However, such kind of foaming agent generally has some significant disadvantages. For example, there is still a residue of the organic foaming agent left in the foam products after the foaming reaction. This leads to safety problem of the foam products. Or the foaming agent has the problem of poor flowability so that the pore size of the foam varies and the quality of the foam is affected.

As to ADCA used during the foaming process, formamide (side product) is derived when micropores are formed owing to incomplete decomposition of ADCA that releases nitrogen gas. The formamide cause damages to people's central nerve system and reproductive system through inhalation and skin contact. Long term contact of formamide may lead to skin irritation and sensitization. Thus various countries including Taiwan and trade organizations worldwide have strict restrictions for control of formamide residue in the foam products. In the future, formamide-free foam becomes the mainstream on the market.

There are certain studies that focus on preparation of formamide-free foam. Refer to Chinese Pat. Pub. No. 103387705A, a slightly alkaline foaming environment is provided under the action of sodium bicarbonate and ADCA for inhibiting formation of formamide and related derivatives during decomposition of ADCA. However, there is still 200 ppm formamide residue in the product. Moreover, the amount of ADCA used is increased along with the increasing expansion ratio of the foam. This means the foam has more formamide residue. Thus the problem of formamide residue in the foam remains.

In order to solve the problem of formamide residue, the most direct way is to prepare the foam without using ADCA. Thus there is a need to provide a novel method for preparing the foam without using ADCA. The foam produced by the novel method is not only having no neurotoxicity and no skin irritation but also environmentally friendly.

### SUMMARY OF THE INVENTION

Therefore it is a primary object of the present invention to provide a formamide-free foam and a method for preparing the same. The products made from the formamide-free foam have no neurotoxicity and no skin irritation so that they pose no risk to the health.

In order to achieve the above object, a method for preparing formamide-free foam of the present invention is provided. The composition of the foam includes a copolymer and a foaming agent. The foaming agent is sodium bicarbonate. The method for preparing formamide-free foam includes a plurality of steps. First the copolymer and the foaming agent are compounded to get an intermediate. Then the intermediate is pressed and injected to form a sheet. Next the intermediate/sheet is irradiated by an electron beam to form crosslinks therein. At last the intermediate is heated and foamed to get a formamide-free foam.

The copolymer used is selected from the group consisting of ethylene vinyl alkanoate copolymer, polyolefin copolymer and their combinations.

The ethylene vinyl alkanoate copolymer used includes ethylene vinyl acetate (EVA) copolymer.

The polyolefin copolymer includes polyethylene (PE) copolymer and polypropylene (PP) copolymer.

During preparation of formamide-free foam, the compounding temperature is ranging from 80° C. to 135° C.

The energy of the electron beam is from 650 KV to 750 KV.

In the step of heating and foaming, the foaming temperature is ranging from 225° C. to 275° C.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein: FIGURE is a flow chart showing steps of a method for preparing formamide-free foam according to the present invention.

### DETAILED DESCRIPTION OF THE PREFERRED EMBODIMENT

In order to learn features and functions of the present invention, please refer to the following embodiments and the detailed description.

In order to solve a common problem of the foam available now that all has formamide residues or other chemical residues, the present invention provides a formamide-free foam and a method for preparing the same. The foam produced has no neurotoxicity, no reproductive toxicity, and no skin irritation. Thus consumers can use the foam products such as carpets, shoe materials, etc. at ease and safely. The foaming agent used has lower cost so that the whole production cost is reduced. Thus manufacturers can provide consumers products with more reasonable cost. For the consumers, the products are cheap but good. A great breakthrough has been made in industrial techniques.

Instead of azodicarbonamide, the present invention uses sodium bicarbonate as the foaming agent used during the foaming process. After sodium bicarbonate being mixed with polymeric material, the mixture has been treated by compounding, pressing, injection, irradiation crosslinking, heating and foaming to get formamide-free foam.

The followings are detailed description of materials, properties and preparation parameters of the foam and the preparation of the same.

The formamide-free foam composition of the present invention includes 50%-95% (weight percent) ethylene vinyl alkanoate copolymer, 5-50 wt % foaming agent (sodium bicarbonate). The formamide-free foam composition further includes polyolefin copolymer. The polyolefin copolymer is blended with a weight percent of a mixture of the ethylene vinyl alkanoate copolymer and the sodium bicarbonate is ranging from 40% to 60% while a weight percent of the polyolefin copolymer is ranging from 40% to 60%

The foaming agent used in the present invention is sodium bicarbonate. Due to the carbon dioxide release property and stable chemical property of sodium bicarbonate while being heated, sodium bicarbonate provides stable foaming efficiency during heating process. Moreover, the foam products will not have no neurotoxicity, no reproductive toxicity, and no skin irritation. The sodium bicarbonate is an environmentally friendly foaming agent.

As to ethylene vinyl alkanoate copolymer of the present invention, an alkyl group of alkanoate includes about 1 to 6 carbon atoms. The ethylene vinyl alkanoate copolymer can be ethylene vinyl acetate (EVA) copolymer, ethylene vinyl propionate (EVP) copolymer, ethylene vinyl butyrate copolymer, ethylene vinyl isobutyrate copolymer, ethylene vinyl pivalate copolymer. ethylene vinyl caproate copolymer, or their combinations.

The ethylene vinyl alkanoate copolymer is preferred to be ethylene vinyl acetate (EVA) copolymer.

The amount of vinyl alkanoate (VA content) in ethylene vinyl acetate used is ranging from 5-60 wt % while 28-55 wt % is preferred.

The polyolefin copolymer of the present invention includes at least one olefin compound. The olefin compounds react to form polymer after polymerization and the polymer is used as a substrate material. The olefin monomer includes ethane, halogen-substituted ethane, propene, isobutene, 1-butene, 1-pentene, 1-hexene, 3-methyl-1-pentene, 4-methyl-1-pentene, 1-octene, nonconjugated diene, polyene, 1,3-Butadiene, isoprene, pentadiene, hexadiene (such as 1,4-hexadiene), octadiene, styrene, halogen-substituted styrene, alkyl-substituted styrene, tetrafluoro ethylene (TFE), vinylbenzocyclobutene, cycloalkane, cycloalkene (such as cyclopentene, cyclohexene, cyclooctene), and their combinations.

Among the polyolefin copolymers, polyethylene (PE) and polypropylene (PP) are preferred.

Refer to FIGURE, a method for preparing a formamide-free foam of the present invention includes the following steps.

Step S11: mixing copolymer and a foaming agent evenly to get a foam composition;
Step S12: compounding the foam composition to get an intermediate;
Step S13 pressing and injecting the intermediate;
Step S14: irradiating the injected intermediate by an electron beam to carry out crosslinking of the intermediate; and
Step S15: heating and foaming the intermediate to get a foam.

In the step S11, the foam composition used of the present invention includes 50%-95% (weight percent) ethylene vinyl alkanoate copolymer, and 5-50 wt % sodium bicarbonate (foaming agent). The foam composition further includes polyolefin copolymer. The polyolefin copolymer includes a weight percent of a mixture of the ethylene vinyl alkanoate copolymer and the sodium bicarbonate is ranging from 40% to 60% while a weight percent of the polyolefin copolymer is ranging from 40% to 60%

In the step S12, the foam composition obtained in the previous step is placed into a plastic blender to react at a compounding temperature of 80° C.-130° C. for a period of time ranging from 210 seconds to 270 seconds. Thus a melt intermediate is obtained.

In the step S13 of pressing and injecting, the melt intermediate obtained in the previous step is placed into a mold of a pressing machine and the mold is clipped between two electrically heated plates and the temperature of the electrically heated plate is set at 80° C.-130° C. Then the melt intermediate is cold pressed for 70-110 seconds at a pressure ranging from 230 pa to 300 pa and injected to form a sheet.

In the step S14 of irradiation crosslinking, the pressed and injected intermediate is irradiated by the electron beam to create various free radicals that recombine to form crosslinks in the intermediate. The electron beam energy is ranging from 650 KV-750 KV.

In the step S15 of heating and foaming, the crosslinked intermediate sheet is heated in a heating space for 30 sec-120 sec while the temperature of the heating space is controlled between 200° C.-300° C. Thus gas generated in the foam/intermediate is dissipated and a formamide-free foam is obtained.

Please refer to the following embodiments so as to learn techniques, features and functions of the present invention.

### Embodiment One

Based on the components and ratio of polymer foam in the following table 1, mix the components evenly to get a mixture. The mixture is placed into a plastic blender to react for 240 seconds while the temperature of a front wheel of the blender is 95° C. and the temperature of a rear wheel of the blender is 90° C. Thus the mixture is heated to melt. Then the melt intermediate is poured into a mold with a thickness of 1 mm. The mold is clipped between two electrically heated plates of a pressing machine and the temperature of the electrically heated plate is set at 96° C. Then the melt intermediate is cold pressed for 90 seconds at the pressure of 260 pa and injected to form a sheet. The pressed and injected intermediate is irradiated by the electron beam having an energy of 700 KV for performing irradiation crosslinking. At last, the crosslinked sheet is delivered into an oven and heated at 250° C. for 60 seconds for foaming. Thus a formamide-free irradiation crosslinked foam of the present invention is obtained.

TABLE 1
composition of polymer foam of the respective embodiment

| | Polymer | | | | Foaming agent | |
|---|---|---|---|---|---|---|
| | compo- | ratio | compo- | ratio | compo- | ratio |
| Embodiment | nent | (%) | nent | (%) | nent | (%) |
| 1 | EVA | 35 | PE | 50 | Na₂CO₃ | 15 |
| 2 | EVA | 30 | PE | 50 | Na₂CO₃ | 20 |
| 3 | EVA | 25 | PE | 50 | Na₂CO₃ | 25 |

Foam Product Properties Test of the Embodiment One

Do a test for formamide residues in foam product of the above embodiment. Also measure and calculate density and expansion ratio of the foam. The test results are shown in the following table.

TABLE 2
product properties of embodiment one,
embodiment two and embodiment three

| | formamide | density | expansion |
|---|---|---|---|
| embodiment | residue (ppm) | (g/L) | ratio |
| 1 | not detected | 0.125 | 8X |
| 2 | not detected | 0.105 | 9.5X |
| 3 | not detected | 0.074 | 13.3X |

The test results prove that no formamide residue is detected in the foam of the present invention. Moreover, the foaming property of the foam is highly correlated with the foaming agent (sodium bicarbonate). The more the foaming agent added in the foam, the higher the expansion ration of the foam and the lower the density of the foam. Thus sodium bicarbonate is essential to the foaming reaction of the foam.

In summary, the foam and the method for preparing the same of the present invention is really formamide-free so that the foam has no neurotoxicity and no skin irritation caused by formamide-free. Moreover, the preparation process is simplified by using only one foaming agent in combination with irradiation crosslinking so that the production cost is reduced. The foam is applied to production of daily essentials such as pads and shoes that are in contact with human bodies.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for preparing a formamide-free foam comprising the steps of:
compounding ethylene vinyl alkanoate copolymer with a weight percent of 50%-95% and a foaming agent with a weight percent of 5%-50% to get an intermediate; wherein the foaming agent is sodium bicarbonate;
pressing and injecting the intermediate;
irradiating the intermediate by an electron beam to carry out crosslinking of the intermediate; and
heating and foaming the intermediate to get the formamide-free foam.

2. The method as claimed in claim 1, wherein the formamide-free foam further includes a polyolefin copolymer;
wherein a weight percent of a mixture of the ethylene vinyl alkanoate copolymer and the sodium bicarbonate is ranging from 40% to 60% while a weight percent of the polyolefin copolymer is ranging from 40% to 60%.

3. The method as claimed in claim 1, wherein the ethylene vinyl alkanoate copolymer is ethylene vinyl acetate (EVA) copolymer.

4. The method as claimed in claim 2, wherein the polyolefin copolymer includes polyethylene (PE) copolymer and polypropylene (PP) copolymer.

5. The method as claimed in claim 1, wherein compounding temperature is ranging from 80° C. to 130° C. in the step of compounding.

6. The method as claimed in claim 1, wherein energy of the electron beam is ranging from 650 KV to 750 KV in the step of irradiating the intermediate by the electron beam.

7. The method as claimed in claim 1, wherein foaming temperature is ranging from 200° C. to 300° C. in the step of heating and foaming the intermediate.
